(19) United States
(12) Patent Application Publication
(10) Pub. No.: US 2025/0363266 A1
(43) Pub. Date: Nov. 27, 2025

(54) HIGH-DAMPING COMPOSITE FLOORS

(71) Applicant: Arup IP Management, Ltd., London (GB)

(72) Inventor: Ishan Kavan Abeysekera, Brooklyn, NY (US)

(73) Assignee: Arup IP Management, Ltd., London (GB)

(21) Appl. No.: 19/215,393

(22) Filed: May 22, 2025

Related U.S. Application Data
(60) Provisional application No. 63/650,419, filed on May 22, 2024.

(51) Int. Cl. G06F 30/23; E04F 15/022; G06F 111/10; G06F 113/26

(52) U.S. Cl. CPC G06F 30/23; E04F 15/022; G06F 2111/10; G06F 2113/26

(57) ABSTRACT

A method of calculating building material damping, and a damped composite building material containing two structural layers sandwiching a viscoelastic interlayer, at least one of the structural layers comprising a composite material such as cross-laminated timber (CLT), CLT and concrete, glue laminated timber (glulam), or glulam and concrete, to reduce structural vibration in the building material when included in a structure.

### CROSS-REFERENCE TO RELATED APPLICATIONS

This application is a U.S. Non-Provisional Utility Patent Application entitled, “HIGH-DAMPING COMPOSITE FLOORS” which claims priority to co-pending U.S. Provisional Patent Application No. 63/650,419, filed on May 22, 2024 entitled, “HIGH-DAMPING COMPOSITE FLOORS” the contents of which are hereby fully incorporated by reference.

### FIELD OF THE EMBODIMENTS

The embodiments described herein generally relate to structural damping systems and, more particularly, to systems and methods for enhancing the dynamic behavior and damping characteristics of partially composite beams, slabs, and floor systems through the incorporation of viscoelastic shear layers at the interface between structural elements. The embodiments further pertain to the use of viscoelastic materials, with or without mechanical fasteners such as screws, to increase damping ratios, reduce resonant response factors, and improve vibration control in timber floors, timber-concrete composite structures, cross-laminated timber (CLT) panels, and similar structural assemblies.

### BACKGROUND

Floors subjected to dynamic loading, such as walking excitation, often experience excessive resonant responses that negatively impact occupant comfort and structural performance. These vibration issues are particularly prevalent in lightweight floor systems where natural damping is low. Under conventional design approaches, structural engineers have limited means to increase the damping capacity of a floor system, leaving such systems vulnerable to undesirable vibration levels. In engineered timber structures, including those constructed from glued laminated timber (glulam) and cross-laminated timber (CLT), this problem is further exacerbated by the inherent material properties and construction methods. Glulam elements, with their parallel grain orientation, and CLT panels, with their crosswise layering for rigidity, both lack mechanisms to dissipate vibrational energy effectively at the system level. As a result, these floor systems are often susceptible to low-frequency vibrations and amplified responses under service loads, creating challenges in meeting performance criteria for vibration control in modern buildings.

### SUMMARY

A product, and a method of calculating product parameters, to increase damping to reduce structural vibration in supported floors containing cross-laminated timber (CLT), timber concrete composites (made of CLT and concrete and glulam+concrete), and steel CLT composites. The method includes measuring a length and width and other physical parameters of a support-free portion of a two-layer supported floor. Simplifying assumptions may also be made to the relevant analytical equations so that calculating a reasonably accurate estimate of resonant response to expected loads such as foot traffic can be calculated by hand. Such assumptions may include, for example, supposing that one or more mode shapes of free vibration of free portions of the floor are approximated by sine waves, and the shear deflection of the layers of a composite floor are negligible. Illustratively, manually calculating a simplified equation describing floor damping should be within about 6% of the damping for the same floor calculated using a finite element analysis (FEA) program.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

In the drawings:

FIGS. 1A and 1B show example building interiors comprising CLT elements, according to some embodiments.

FIG. 2A shows side and cross sectional views of a viscoelastic layer between the top and bottom layers of a partially composite beam, according to some embodiments.

FIG. 2B shows an example beam layer for illustrating certain equation variables, according to some embodiments.

FIGS. 3A and 3B show a representative CLT/bituthene/CLT sandwich panel with a viscoelastic interlayer, and a graph showing the damping ratio vs the viscoelastic layer thickness, according to some embodiments.

FIG. 4A shows an example floor scheme, according to some embodiments.

FIG. 4B illustrates a table that presents a comparative analysis of three structural configurations designed to assess the effect of incorporating a viscoelastic interlayer within a cross-laminated timber (CLT) floor system on its vibration performance, according to some embodiments.

FIGS. 5A, 5B, and 5C illustrate three elements that may be used in supported floors where one or more viscoelastic layers can be introduced to increase damping, according to some embodiments.

FIG. 6 shows damping information for a composite floor comprising CLE with a concrete topping, according to some embodiments.

FIG. 7 shows three cases with increasing damping, showing the reduced resonant response to foot traffic as damping is increased, according to some embodiments.

FIG. 8 illustrates a graph 800 showing an example of additional damping achieved in an 11-meter-spanning floor system comprising a 320 mm thick cross-laminated timber (CLT) panel with an 80 mm timber topping, evaluated across a range of temperatures and excitation frequencies, according to some embodiments.

FIG. 9 illustrates a graph 900 representing the relationship between interlayer thickness and additional damping for a structural floor system configured with a 7-meter span, 200 mm thick cross-laminated timber (CLT) panel, and an 80 mm timber topping, according to some embodiments.

### DETAILED DESCRIPTION

It is to be understood that the figures and descriptions provided herein may have been simplified to illustrate aspects that are relevant for a clear understanding of the herein described processes, machines, manufactures, and/or compositions of matter, while eliminating, for the purpose of clarity, other aspects that may be found in typical devices, systems, and methods. Those of ordinary skill in the pertinent art may recognize that other elements and/or steps may be desirable and/or necessary to implement the devices, systems, and methods described herein. Because such elements and steps are well known in the art, and because they do not facilitate a better understanding of the present disclosure, a discussion of such elements and steps may not be provided herein. However, the present disclosure is deemed to inherently include all such elements, variations, and modifications to the described aspects that would be known to those of ordinary skill in the pertinent art.

It will be readily understood that the components of the present invention, as generally described and illustrated in the figures herein, may be realized in a variety of different configurations. Thus, the following detailed description of the embodiments of a method, apparatus, and system, as represented in the attached figures, is not intended to limit the scope of the invention as claimed, but is merely representative of selected illustrative embodiments of the invention. The usage of the phrases “example embodiments”, “some embodiments”, or other similar language, throughout this specification refers to the fact that a particular feature, structure, or characteristic described in connection with the embodiment may be included in at least one embodiment of the present invention, and do not necessarily all refer to the same group of embodiments.

The present disclosure relates to systems and methods for improving the damping characteristics of floor structures subject to resonant responses, particularly those resulting from dynamic excitations such as pedestrian activity. Under conventional design conditions, opportunities for increasing the damping ratio of floor systems are limited, resulting in elevated resonant response factors and reduced occupant comfort. The disclosed embodiments address these issues by introducing viscoelastic layers at shear interfaces within floor assemblies. The inclusion of viscoelastic materials between structural elements can significantly enhance damping performance by dissipating vibrational energy, thereby reducing resonant responses. Such implementations are particularly applicable to timber floors constructed with partially composite timber elements and timber-concrete composite systems. Additionally, the disclosure provides a simplified analytical approach for estimating the damping ratio introduced by viscoelastic layers. This method eliminates the need for complex finite element modeling by utilizing a hand-calculation technique, enabling efficient evaluation of damping characteristics in structural designs incorporating viscoelastic materials.

SLS vibration criteria for user comfort is one of the key drivers of floor designs containing cross-laminated timber (CLT). Typical floor spans may experience dynamic forces of frequency fₙ≤10 Hz, for example, as a result of being walked on. As a result, they are prone to resonant excitation. In general, floor element acceleration is indicated by F_{dyn}/M×Dynamic Amplification Factor (DAF).

Potential ways to mitigate resonant vibration include increasing at least one of a system's mass, stiffness, or damping. Unfortunately, in some cases adding mass may make the problem worse. And, adding stiffness can be very difficult, and may necessitate reducing grid sizes, adding to the cost of a project. However for resonant response, increasing damping provides the biggest improvement. Further, in most cases damping is more a function of the system, rather than some other factor the designer can control. This consideration may simplify analysis of the resonant vibration of a given system. Accordingly, increasing damping is a favored approach to mitigating resonant vibration.

A variety of embodiments will now be described. These embodiments are provided as teaching examples and should not be interpreted to limit the scope of the invention. Although specific details of the embodiments are presented, these embodiments may be modified by changing, supplementing, or eliminating many of these details. Viscoelastic layers between elements in composite floors at the shear interface may lead to a significant increase in damping and lower resonant response. One or more viscoelastic layers may be used to increase damping in floors with at least partially composite timber elements such as beams or layers, or for timber-concrete composites.

One method of calculating additional damping due to a viscoelastic layer is by modeling the viscoelastic layer as spring elements between two other layers in finite element (FE) analysis. The damping ratio of a system of elements depends on the material damping of the elements, and the proportion of strain energy in the elements in relation to the total strain energy in the system. This can be described by the equation:

$${ζ}_{eff , n} = \frac{{Σξ}_{e} {U}_{e , n}}{Σ {U}_{e , n}}$$

### Where:

ξ_{eff,n}—is the effective damping of the system for a given mode n
ξₑ—is the material damping of the element
U_{e,n}—is the total strain energy of the element i for a given mode n

This may be solved using a finite element analysis (FEA) program on a computer, for example, GSA software by Oasis, 8 Fitzroy Street, London United Kingdom W1T 4BJ (or other FEA software) as follows:

$${ζ}_{eff , n} = \frac{{Σ}_{e = 1}^{N} \frac{1}{2} {ξ}_{e} {φ}_{n}^{T} {K}_{e}^{G l} {φ}_{n}}{\frac{1}{2} {φ}_{n}^{T} K {φ}_{n}} = \frac{{Σ}_{e = 1}^{N} {ξ}_{e} {φ}_{n}^{T} {K}_{e}^{G l} {φ}_{n}}{{φ}_{n}^{T} K {φ}_{n}}$$

ξₑ—is the effective damping of the system for a given mode m

$${φ}_{n}^{T}$$

—Transpose of mode shape vector for mode m

$${K}_{e}^{G l}$$

—Stiffness matrix of element e alone expanded into the global stiffness matrix space
φₙ—Mode shape vector for mode m
K—K is the global stiffness matrix

Note, the denominator above is the energy of the sum of a plurality N of elements for a given mode multiplied by the damping ratio of respective ones of the elements, and that the denominator is the total energy.

Alternatively, a simpler hand-calculation method may be used to work out usefully accurate damping ratios of system elements having a viscoelastic layer, such as simply supported, partially composite beams that are subjected to sinusoidal loading, for example from people walking on it, or from impacts, or the like. The same equations can be used generally for composite layups in any materials to model vibrations within the elastic limit.

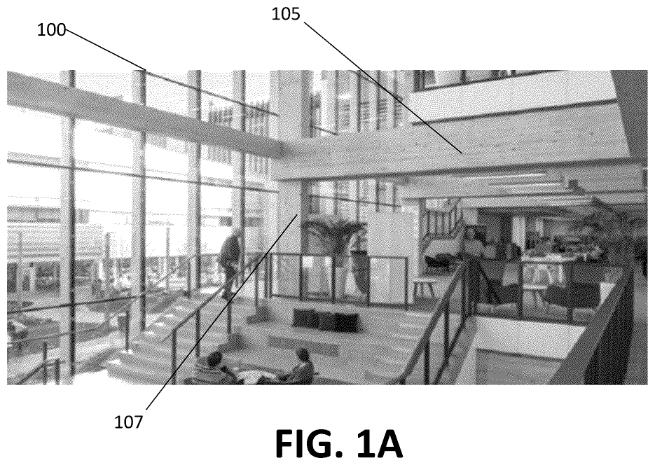

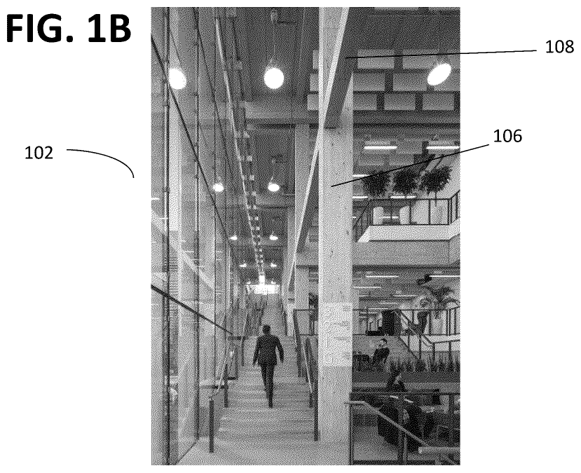

FIGS. 1A and 1B illustrate example building interiors incorporating cross-laminated timber (CLT) structural elements. In FIG. 1A, a perspective view of a multi-level open-plan interior space 100 is shown, featuring exposed CLT beams 105 and columns 107 integrated into the architectural design. The structural CLT elements support upper floor levels and ceilings while contributing to the aesthetic appeal of the space. Large glazing panels along the perimeter provide natural lighting, and the open configuration includes stairways and elevated platforms facilitating pedestrian circulation within the building. The use of CLT elements in the floor and ceiling structures may be subject to dynamic excitation from occupant movement, highlighting potential vibration performance considerations in such environments.

FIG. 1B depicts a vertical view of a similar interior space implementing a composite building material (composite) 102 that damps structural vibrations and illustrating exposed CLT columns 106 and beams 108 positioned throughout the space, supporting multiple floor levels and open mezzanines. The figure further illustrates potential pathways for vibration transmission through the structural elements, including areas where walking-induced excitation may lead to resonant responses. Lighting fixtures and suspended ceiling panels are shown integrated with the exposed CLT framework, providing both functional and architectural enhancements. The configurations shown in FIGS. 1A and 1B exemplify the use of CLT as a primary structural material in modern architectural designs, where considerations for occupant comfort and vibration control are provided, especially in large open spaces subjected to dynamic loading.

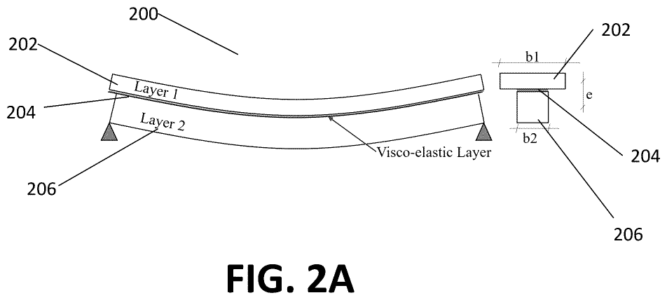

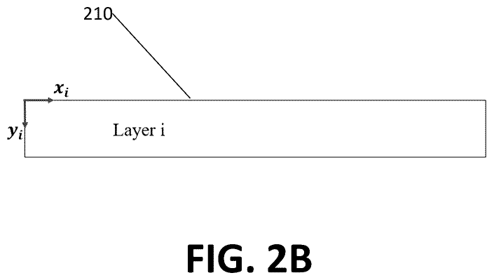

FIG. 2A shows side and cross sectional views of a viscoelastic layer disposed between the top and bottom layers of a partially composite beam in anapplication of theory to a partially composite beam 200. This arrangement can result in a significant increase in damping of the composite beam due to shearing of the viscoelastic layer as the beam vibrates. The beam assembly 200 comprises a first structural layer 202 (“Layer 1”) and a second structural layer 206 (“Layer 2”) arranged in a vertically stacked configuration. A viscoelastic layer 204 is disposed between the first and second layers 202, 206, providing a shear interface configured to dissipate vibrational energy during dynamic excitation of the beam assembly. The first structural layer 202 has a width dimension denoted as b1, and the second structural layer 206 has a width dimension denoted as b2. The vertical separation between the centroids of the two structural layers is represented by e.

The beam assembly 200 is illustrated in a simply supported configuration with supports 206 located near its ends, permitting flexural deformation under applied loads. When the beam undergoes bending, relative displacement between the first and second structural layers 202, 206 induces shear deformation in the viscoelastic layer 204. This deformation allows the viscoelastic material to dissipate vibrational energy, effectively increasing the damping ratio of the system. The configuration shown in FIG. 2A is representative of composite structural systems where damping enhancements are achieved through the integration of viscoelastic materials at the shear interface. Such systems may be used in floor structures, beams, and other applications requiring improved vibration performance and occupant comfort.

The governing equations for the dynamic behavior of a partially composite beam where shear of the layers other than the viscoelastic layers is significant are very difficult to solve by hand. However, it is much easier to obtain a reasonably accurate estimate for such a problem by assuming that the mode shapes of free vibration are well approximated by one or more sine waves. The shear deflection of the layers other than the viscoelastic layer are negligible.

FIG. 2B illustrates a schematic representation of a structural layer 210 within a composite beam assembly. The structural layer 210, labeled as “Layer i,” represents a generalized layer within a multilayered assembly, which may be subjected to bending and shear deformations under applied loads. A local coordinate system is defined at the layer, with axis xi extending along the longitudinal direction of the layer and axis yi extending in the vertical direction perpendicular to the longitudinal axis. This local coordinate system facilitates analysis of axial and bending stresses, strain distributions, and deformation behavior within the individual layer. The use of layer-specific coordinate systems is critical in modeling strain energy contributions and evaluating the dynamic response of multilayer assemblies, particularly when assessing partial composite action and damping effects introduced by interlayers such as viscoelastic materials. The representation of Layer i in FIG. 2B is exemplary and may apply to various materials, including but not limited to timber, engineered wood products, concrete, or composite materials, depending on the structural application.

As noted above, FIG. 2B shows an example beam layer i 210 with xᵢ and yᵢ shown for illustration of the equations below. From the solutions provided for sinusoidal loading, it is possible to work out the strain profile due to partially composite bending for each layer:

$${ε}_{1} ( x , {y}_{1} ) = [ {w}_{max}^{″} ( \frac{{h}_{1}}{2} - {y}_{1} ) + \frac{{N}_{max}}{{( E A )}_{1}} ] sin ( \frac{π x}{l} )$$

$${ε}_{2} ( x , {y}_{2} ) = [ {w}_{max}^{″} ( \frac{{h}_{2}}{2} - {y}_{2} ) - \frac{{N}_{max}}{{( E A )}_{2}} ] sin ( \frac{π x}{l} )$$

With maximum curvature and axial force in the layers given by:

$${w}_{max}^{″} = \frac{{{p}_{0} ( \frac{π}{l} )}^{2} ( \frac{μ}{{π}^{2} + {α}^{2}} - 1 )}{{( EI )}_{1} + {( EI )}_{2}}$$

$${N}_{max} = {{p}_{0} ( \frac{π}{l} )}^{2} ( \frac{μ}{e {α}^{2}} ) ( 1 - \frac{{π}^{2}}{{π}^{2} + {α}^{2}} )$$

### With:

$${α}^{2} = ( \frac{1}{{( E A )}_{1}} + \frac{1}{{( E A )}_{2}} + \frac{{e}^{2}}{{( EI )}_{1} + {( EI )}_{2}} ) {k}_{s} {l}^{2}$$

$$μ = ( \frac{{k}_{s} {l}^{2} {e}^{2}}{{( EI )}_{1} + {( EI )}_{2}} )$$

### Where:

pₒ—Peak distributed inertial load
(EI)₁—Effective flexural stiffness of layer 1
(EI)₂—Effective flexural stiffness of layer 2
(EA)₁—Effective axial stiffness of layer 1
(EA)₂—Effective axial stiffness of layer 2
e—distance between centroids of the 2 layers
kₛ—is the smeared shear stiffness of the viscoelastic layer (can have units of N/m per m run)
Note—Compressive strain is taken as positive.

The total strain energy in the beam is given by:

$${U}_{b} = {U}_{b 1} + {U}_{b 2}$$

$${U}_{b} = \frac{{E}_{1} {b}_{1}}{2} {\int }_{0}^{l} {\int }_{0}^{{h}_{1}} {ε}_{1}^{2} d {y}_{1} d {x}_{1} + \frac{{E}_{2} {b}_{2}}{2} {\int }_{0}^{l} {\int }_{0}^{{h}_{2}} {ε}_{2}^{2} d {y}_{2} d {x}_{2}$$

$${U}_{b} = \frac{{E}_{1} {b}_{1} l}{2} [ \frac{{( {w}_{max}^{″} )}^{2} {h}_{1}^{3}}{24} + \frac{{N}_{max}^{2} {h}_{1}}{2 {( EA )}_{1}^{2}} ] + \frac{{E}_{2} {b}_{2} l}{2} [ \frac{{( {w}_{max}^{″} )}^{2} {h}_{2}^{3}}{24} + \frac{{N}_{max}^{2} {h}_{2}}{2 {( EA )}_{2}^{2}} ]$$

The shear strain energy due to shearing of the viscoelastic layer is given by:

$${U}_{S} = \frac{1}{2} {\int }_{0}^{l} \frac{{[ ν ( x ) ]}^{2}}{{k}_{s}} d x$$

The shear flow along the beam v(x) is given by:

$$v ( x ) = {v}_{max} cos ( \frac{π x}{l} )$$

Hence shear strain energy at the interlayer is given by:

$${U}_{S} = \frac{{v}_{max}^{2} l}{4 {k}_{s}}$$

$${v}_{max} = {P}_{max} \cdot \frac{l}{π} \cdot \frac{μ}{e {α}^{2}} \cdot ( 1 - \frac{{π}^{2}}{{π}^{2} + {α}^{2}} )$$

The equivalent damping of the partially composite beam is:

$${ξ}_{eff , n} = \frac{{U}_{S , n}}{{U}_{T ot , n}} = \frac{{ξ}_{1} {U}_{b 1} + {ξ}_{2} {U}_{b 2} + {ξ}_{s} {U}_{S}}{{U}_{b 1} + {U}_{b 2} + {U}_{S}}$$

$${ξ}_{eff , n} = {ξ}_{eff , n , s} + {ξ}_{eff , n , 1} + {ξ}_{eff , n , 2}$$

### With:

$${ξ}_{eff , n , s} = \frac{{ξ}_{s} {μ}^{2} {π}^{2} ( {D}_{1} + {D}_{2} )}{{l}^{2} {e}^{2} {k}_{s} ( {π}^{2} + {α}^{2} - μ ) ( {π}^{2} + {α}^{2} )}$$

$${ξ}_{eff , n , 1} = \frac{{ξ}_{1} [ {C}_{1}^{2} {e}^{2} {h}_{1}^{2} {( {π}^{2} + {α}^{2} - μ )}^{2} + 12 {{μ}^{2} ( {D}_{1} + {D}_{2} )}^{2} ]}{12 {C}_{1} {e}^{2} ( {D}_{1} + {D}_{2} ) ( {π}^{2} + {α}^{2} - μ ) ( {π}^{2} + {α}^{2} )}$$

$${ξ}_{eff , n , 2} = \frac{{ξ}_{2} [ {C}_{2}^{2} {e}^{2} {h}_{2}^{2} {( {π}^{2} + {α}^{2} - μ )}^{2} + 12 {{μ}^{2} ( {D}_{1} + {D}_{2} )}^{2} ]}{12 {C}_{2} {e}^{2} ( {D}_{1} + {D}_{2} ) ( {π}^{2} + {α}^{2} - μ ) ( {π}^{2} + {α}^{2} )}$$

Given that even mode shapes are all sine waves in the above, and:

D₁—Effective flexural stiffness of layer 1
D₂—Effective flexural stiffness of layer 2
C₁—Effective axial stiffness of layer 1
C₂—Effective axial stiffness of layer 2

Given the assumption that mode shapes are all sine waves, the above equation can be used to calculate the damping of any mode n with n half sine waves by setting:

$$l = \frac{span}{n}$$

In some instances, the shear layer will have a viscoelastic layer as well as screws. Clearly the damping from such a system will be lowered when compared to one with no screws for the following reasons: The screws will restrain the overall shear slip and strain reducing the damping provided by the visco elastic layer. The relative strain energy of the visco elastic layer to the total strain energy is reduced therefore reducing overall damping.

Derivation of an expression for the equivalent damping of a 2 layer composite beam where the interlayer consists of a visco elastic layer and screws:

The equivalent damping of the partially composite beam is:

$${ξ}_{eff , n} = \frac{{U}_{S , n}}{{U}_{Tot , n}} = \frac{{ξ}_{1} {U}_{b 1} + {ξ}_{2} {U}_{b 2} + {ξ}_{ss} {U}_{ss} + {ξ}_{sv} {U}_{sv}}{{U}_{b 1} + {U}_{b 2} + {U}_{ss} + {U}_{sv}}$$

$${U}_{ss} = \frac{{v}_{max , s}^{2} l}{4 {k}_{ss}}$$

$${U}_{sv} = \frac{{v}_{max , v}^{2} l}{4 {k}_{sv}}$$

Noting that the total shear stiffness is:

$${k}_{s} = {k}_{s s} + {k}_{s v}$$

kₛᵥ—the smeared shear stiffness of the viscoelastic layer
kₛₛ—the smeared shear stiffness of the screws
kₛ—the combined smeared shear stiffness of the screws and viscoelastic layer

And:

$${v}_{max , s} = {v}_{max} ( \frac{{k}_{s s}}{{k}_{s s} + {k}_{s v}} )$$

$${v}_{max , v} = {v}_{max} ( \frac{{k}_{s v}}{{k}_{s s} + {k}_{s v}} )$$

We have

$${U}_{s s} = \frac{{v}_{max}^{2} {k}_{s s} l}{4 {( {k}_{s s} + {k}_{s v} )}^{2}} = \frac{{v}_{max}^{2} l}{4 {k}_{s}} ( \frac{{k}_{s s}}{{k}_{s}} )$$

$${U}_{s v} = \frac{{ν}_{max}^{2} l}{4 {k}_{s}} ( \frac{{k}_{s v}}{{k}_{s}} )$$

$${ξ}_{s} = \frac{{ξ}_{s s} {U}_{s s} + {ξ}_{s v} {U}_{s v}}{{U}_{s}} = {ξ}_{s s} ( \frac{{k}_{s s}}{{k}_{s}} ) + {ξ}_{s v} ( \frac{{k}_{s v}}{{k}_{s}} )$$

$${ξ}_{e f f , n , s} = \{ {ξ}_{s s} ( \frac{{k}_{s s}}{{k}_{s}} ) + {ξ}_{s v} ( \frac{{k}_{s v}}{{k}_{s}} ) \} ( \frac{{μ}^{2} {π}^{2} ( {D}_{1} + {D}_{2} )}{{l}^{2} {e}^{2} {k}_{s} ( {π}^{2} + {a}^{2} - μ ) ( {π}^{2} + {a}^{2} )} )$$

So the equivalent damping of a partially composite beam or panel where the interlayer between the 2 structural elements consists of a visco elastic material and screws is given by:

$${ξ}_{eff , n} = {ξ}_{eff , n , ss} + {ξ}_{eff , n , sv} + {ξ}_{eff , n , 1} + {ξ}_{eff , n , 2}$$

$${ξ}_{eff , n , ss} = {ξ}_{s s} ( \frac{{k}_{s s}}{{k}_{s}} ) ( \frac{{μ}^{2} {π}^{2} ( {D}_{1} + {D}_{2} )}{{l}^{2} {e}^{2} {k}_{s} ( {π}^{2} + {α}^{2} - μ ) ( {π}^{2} + {α}^{2} )} )$$

$${ξ}_{eff , n , sv} = {ξ}_{s v} ( \frac{{k}_{s v}}{{k}_{s}} ) ( \frac{{μ}^{2} {π}^{2} ( {D}_{1} + {D}_{2} )}{{l}^{2} {e}^{2} {k}_{s} ( {π}^{2} + {α}^{2} - μ ) ( {π}^{2} + {α}^{2} )} )$$

$${ξ}_{eff , n , 1} = \frac{{ξ}_{1} [ {C}_{1}^{2} {e}^{2} {h}_{1}^{2} {( {π}^{2} + {α}^{2} - μ )}^{2} + 12 {{μ}^{2} ( {D}_{1} + {D}_{2} )}^{2} ]}{12 {C}_{1} {e}^{2} ( {D}_{1} + {D}_{2} ) ( {π}^{2} + {α}^{2} - μ ) ( {π}^{2} + {α}^{2} )}$$

$${ξ}_{eff , n , 2} = \frac{{ξ}_{2} [ {C}_{2}^{2} {e}^{2} {h}_{2}^{2} {( {π}^{2} + {α}^{2} - μ )}^{2} + 12 {{μ}^{2} ( {D}_{1} + {D}_{2} )}^{2} ]}{12 {C}_{2} {e}^{2} ( {D}_{1} + {D}_{2} ) ( {π}^{2} + {α}^{2} - μ ) ( {π}^{2} + {α}^{2} )}$$

As noted above, In certain composite beam configurations, the interlayer between structural elements includes both a viscoelastic material and mechanical fasteners, such as screws. While the viscoelastic layer contributes to increased damping through energy dissipation, the presence of screws reduces the system's overall damping effectiveness for two primary reasons: (1) the screws constrain shear slip and strain, thereby limiting the deformation and energy dissipation capacity of the viscoelastic layer, and (2) the proportion of strain energy absorbed by the viscoelastic layer relative to the total system strain energy is reduced, further decreasing the overall damping ratio.

An analytical expression has been derived to calculate the equivalent damping ratio (ξ_eff,n) for such systems. This expression accounts for the combined effects of the viscoelastic layer and screws, as well as the contributions from the structural layers. The total equivalent damping is expressed as the sum of individual damping components from the screws (ξ_eff,n,ss), the viscoelastic layer (ξ_eff,n,sv), and the two structural layers (ξ_eff,n,1 and ξ_eff,n,2). The damping contributions are influenced by the stiffness ratios of the screws and viscoelastic layer (k_ss and k_sv), the geometrical and material properties of the structural layers, and dynamic parameters such as mode shapes and vibration frequencies. The equations provide a comprehensive framework for predicting the damping behavior of partially composite beams or panels under vibrational loading conditions. This formulation allows engineers to accurately estimate the damping performance of complex layered structures without resorting to full numerical simulations.

In some embodiments, the viscoelastic layer may be formed from non-conventional or less commonly used materials specifically engineered or selected for enhanced damping performance under specialized conditions. These materials may include advanced polymer composites, phase change materials, or hybrid formulations designed to exhibit superior energy dissipation characteristics while meeting structural compatibility and durability requirements. For example, thermoplastic elastomers (TPEs) blended with proprietary damping additives may be utilized to achieve a high loss factor over a wide frequency range. Such materials offer the advantage of thermoplastic processing combined with elastomeric behavior, allowing for efficient manufacturing and installation while maintaining excellent vibration attenuation properties. In certain embodiments, nanocomposite materials incorporating nanoscale fillers such as graphene, carbon nanotubes, or silica nanoparticles are used to enhance the mechanical strength and damping efficiency of the viscoelastic layer. These nanofillers improve the energy dissipation capacity by increasing internal friction and promoting micro-scale deformation mechanisms within the material.

In other embodiments, phase change materials (PCMs) embedded within a polymer matrix may be used to further improve damping characteristics. These materials leverage latent heat absorption and release during phase transitions to absorb vibrational energy, providing an additional energy dissipation mechanism beyond conventional viscoelastic deformation. PCMs may be particularly useful in structures subjected to cyclical thermal and mechanical loading where temperature variations can be exploited to enhance damping effects. Additionally, bio-based polymers such as modified lignin-based elastomers or cellulose-derived polymers may be used in sustainable construction applications. These materials offer a renewable alternative to petroleum-based polymers and can be chemically modified to achieve desirable viscoelastic properties. While not traditionally used for structural damping, advancements in material science have made such bio-based materials viable options for enhancing sustainability without compromising performance.

In some high-performance applications, the viscoelastic layer may incorporate magnetorheological or electrorheological materials, which allow for the dynamic adjustment of damping characteristics through the application of magnetic or electric fields. This enables active control of vibration damping properties in real time, offering significant benefits in adaptive structural systems where damping requirements may vary based on loading conditions. These non-conventional material options provide expanded design flexibility, allowing engineers to tailor the damping characteristics of the viscoelastic layer to meet highly specific structural and environmental performance objectives beyond those achievable with conventional materials.

### Validation and Comparison Against a GSA Model

A validation study was conducted to compare the accuracy of a proposed hand calculation method for determining the damping ratio of simply supported partially composite beams against results obtained using the Oasys GSA finite element model. Six beam configurations with varying material properties, geometries, and damping characteristics were analyzed. Key parameters included variations in beam heights, material stiffness (E₁, E₂), shear modulus (G₁, G₂, Gₛ), damping ratios (ξ₁, ξ₂, ξₛ), and densities (ρ₁, ρ₂). The comparison focused on the first mode natural frequency and the corresponding damping ratio. Results showed that the hand calculation method provided a close approximation to the GSA model for all cases, with frequency and damping ratio values aligning well within acceptable margins of error. The percentage difference in damping ratios between the methods remained low, typically within a few percentage points. The slight discrepancies observed were attributed to the fact that the Oasys GSA model accounts for the shear strain effects of the two main structural beams, while the hand calculation method simplifies the analysis by neglecting these effects to streamline the calculation process. Despite this simplification, the hand calculation approach demonstrated sufficient accuracy for practical engineering applications, offering a reliable and efficient alternative to more complex numerical modeling techniques for evaluating the damping behavior of partially composite beams.

Six simply supported partially composite beams with the following properties were calculated by hand and compared against GSA:

| | Model 1 | Model 2 | Model 3 | Model 4 | Model 5 | Model 6 |
|---|---|---|---|---|---|---|
| l | 10 | 10 | 10 | 10 | 10 | 10 |
| b₁ (m) | 0.26 | 0.26 | 0.26 | 0.26 | 0.26 | 0.26 |
| b₂ (m) | 0.26 | 0.26 | 0.26 | 0.26 | 0.26 | 0.26 |
| bₛ (m) | 0.26 | 0.26 | 0.26 | 0.26 | 0.26 | 0.26 |
| h₁ (m) | 0.3 | 0.3 | 0.2 | 0.2 | 0.2 | 0.1 |
| h₁ (m) | 0.3 | 0.3 | 0.4 | 0.4 | 0.4 | 0.1 |
| tₛ (m) | 0.0015 | 0.0015 | 0.0015 | 0.0015 | 0.0015 | 0.0015 |
| ξ₁ | 0 | 0 | 0 | 0.03 | 0.03 | 0.02 |
| ξ₂ | 0 | 0 | 0 | 0.02 | 0.02 | 0.02 |
| ξ₃ | 0.375 | 0.375 | 0.375 | 0.375 | 0.375 | 0.375 |
| E₁ (N/m²) | 1 × 10¹⁰ | 1 × 10¹⁰ | 2.8 × 10¹⁰ | 2.8 × 10¹⁰ | 2.8 × 10¹⁰ | 1 × 10¹⁰ |
| E₂ (N/m²) | 1 × 10¹⁰ | 1 × 10¹⁰ | 1 × 10¹⁰ | 1 × 10¹⁰ | 1 × 10¹⁰ | 1 × 10¹⁰ |
| G₁ (N/m²) | 0.069 × 10¹⁰ | 0.33 × 10¹⁰ | 1.1667 × 10¹⁰ | 1.1667 × 10¹⁰ | 1.1667 × 10¹⁰ | 0.069 × 10¹⁰ |
| G₂ (N/m²) | 0.069 × 10¹⁰ | 0.33 × 10¹⁰ | 0.069 × 10¹⁰ | 0.069 × 10¹⁰ | 0.33 × 10¹⁰ | 0.069 × 10¹⁰ |
| Gₛ (N/m²) | 1.17 × 10⁶ | 1.17 × 10⁶ | 1.17 × 10⁶ | 1.17 × 10⁶ | 1.17 × 10⁶ | 1.17 × 10⁶ |
| ρ₁ (kg/m³) | 420 | 420 | 2500 | 2500 | 2500 | 420 |
| ρ₂ (kg/m³) | 420 | 420 | 420 | 420 | 420 | 420 |
| ρₛ (kg/m³) | 0 | 0 | 0 | 0 | 0 | 0 |
| dl mass | 176.6 | 176.6 | 176.6 | 176.6 | 176.6 | 176.6 |
| (kg) | | | | | | |

Comparison:

| | MATLAB/hand calc | | | Oasys GSA | | % Difference | |
|---|---|---|---|---|---|---|---|
| | Freq1 | add zeta | zeta | Freq1 | zeta | f_def | zeta_def |
| Model 1 | 6.5 | 4.3 | 4.3 | 6.2 | 4.1 | 4.6 | 5.3 |
| Model 2 | 6.5 | 4.3 | 4.3 | 6.3 | 4.2 | 2.8 | 1.8 |
| Model 3 | 6.6 | 5.9 | 5.9 | 6.3 | 5.6 | 3.5 | 5.5 |
| Model 4 | 6.6 | 5.9 | 7.9 | 6.3 | 7.6 | 3.5 | 3.9 |
| Model 5 | 6.6 | 5.9 | 7.9 | 6.5 | 7.8 | 1.6 | 1.4 |
| Model 6 | 1.5 | 1.7 | 3.6 | 1.4 | 3.5 | 4.6 | 1.0 |

As noted above, from the above comparison, it can be observed that for the first mode of vibration, the hand calculation method proposed provides a very good match with the results obtained from the Oasys GSA finite element model. This indicates that the simplified analytical approach is capable of accurately predicting the dominant dynamic behavior of partially composite beams under typical service conditions. The close correlation between the predicted natural frequencies and damping ratios across all six models validates the effectiveness of the hand calculation method, particularly for initial design assessments and parametric studies where computational efficiency is important. The slight differences observed between the two methods can be attributed primarily to the level of detail included in the respective analyses. The Oasys GSA model employs a more comprehensive finite element formulation that explicitly accounts for the shear deformation effects in both structural layers of the beam assembly. This includes consideration of shear strain energy contributions within each beam, which tend to influence both the stiffness and damping characteristics, especially for deeper beams or cases where shear flexibility is non-negligible.

In contrast, the hand calculation method intentionally simplifies the analysis by assuming negligible shear deformation in the primary structural layers. This assumption reduces the complexity of the calculations, making the method more accessible for hand-based evaluations but introducing minor inaccuracies when compared to a fully detailed finite element analysis. Despite this simplification, the dominant flexural behavior remains well captured, and the damping predictions remain within acceptable engineering tolerances for first-mode responses. This level of agreement demonstrates that, while the hand calculation method may not capture all secondary effects present in a detailed numerical model, it is a highly effective tool for practical engineering purposes, offering a balance between analytical rigor and computational simplicity.

### Damping of First Mode of a Simply Supported CLT Slab With 65 mm Concrete Topping and 1.5 mm Viscoelastic Layer

An evaluation of the damping performance of simply supported cross-laminated timber (CLT) slabs with a 65 mm concrete topping and a 1.5 mm viscoelastic layer was conducted to assess the impact of the viscoelastic layer on vibration control. The study analyzed slabs of varying lengths from 5.5 meters to 10.5 meters to observe how changes in span influence damping effectiveness and the corresponding reduction in vibrational response. In the cases, the damping ratio without the viscoelastic layer remained constant at approximately 3.5%, which is typical for bare CLT-concrete composite systems. However, when the viscoelastic layer was introduced at the shear interface between the CLT and the concrete topping, a significant improvement in damping was observed across all slab lengths. For shorter spans, such as the 5.5-meter slab, the damping ratio increased dramatically from 3.5% to 9.1%, resulting in a 62% reduction in resonant response. This demonstrates the high effectiveness of the viscoelastic layer in controlling floor vibrations for shorter spans where dynamic responses are more easily mitigated. As the span length increased, the effectiveness of the viscoelastic layer, while still notable, exhibited a gradual reduction. For instance, at a span of 7 meters, the damping ratio with the viscoelastic layer was measured at 6.8%, corresponding to a 48% reduction in response. At the longest tested span of 10.5 meters, the damping ratio with the viscoelastic layer was 4.8%, yielding a 27% reduction in response compared to the baseline without the viscoelastic layer.

This trend indicates that while the inclusion of a viscoelastic layer consistently improves damping performance, the relative benefit decreases as the span length increases. This is primarily due to the fact that longer spans experience lower natural frequencies and larger deflections, which reduce the relative shear deformation across the viscoelastic interface. As a result, the energy dissipation capability of the viscoelastic material becomes less pronounced in controlling the first mode of vibration. Nevertheless, even at longer spans, the viscoelastic layer provides a meaningful reduction in vibrational response, which can be critical in meeting design criteria for occupant comfort and serviceability, especially in office spaces and residential buildings. These results demonstrate that the strategic implementation of a thin viscoelastic layer can be an effective and practical solution for vibration mitigation across a range of structural spans in CLT-concrete composite floor systems.

| | | | % | % | |
|---|---|---|---|---|---|
| | | | Damping | Damping | % |
| | | Concrete | without | with | Reduction |
| Length | CLT | topping | viscoelastic | viscoelastic | in |
| (m) | (m) | (m) | layer | layer | response |
| 5.5 | 0.16 | 0.065 | 3.5 | 9.1 | 62 |
| 6 | 0.16 | 0.065 | 3.5 | 8.4 | 58 |
| 6.5 | 0.16 | 0.065 | 3.5 | 7.7 | 54 |
| 7 | 0.2 | 0.065 | 3.5 | 6.8 | 48 |
| 7.5 | 0.2 | 0.065 | 3.5 | 6.3 | 44 |
| 8 | 0.2 | 0.065 | 3.5 | 5.9 | 41 |
| 8.5 | 0.2 | 0.065 | 3.5 | 5.5 | 37 |
| 9 | 0.22 | 0.065 | 3.5 | 5.8 | 40 |
| 9.5 | 0.22 | 0.065 | 3.5 | 5.5 | 36 |
| 10 | 0.24 | 0.065 | 3.5 | 5.1 | 31 |
| 10.5 | 0.24 | 0.065 | 3.5 | 4.8 | 27 |

### Effect of Interlayer Thickness on Damping Ratio of the System

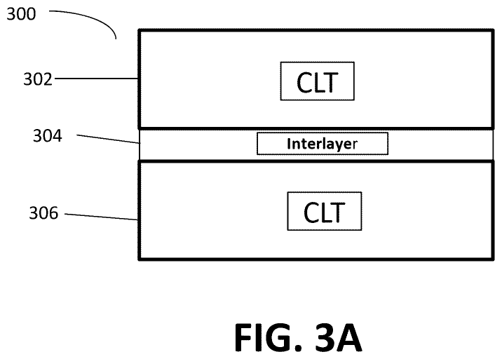

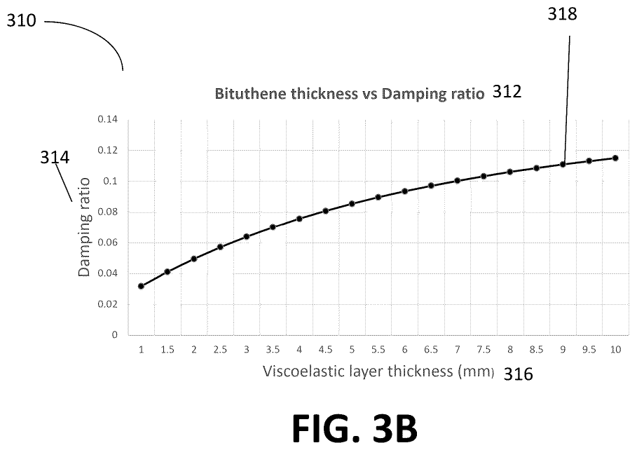

FIG. 3A illustrates an example cross-laminated timber (CLT) sandwich panel assembly 300 incorporating a viscoelastic interlayer for enhanced damping, according to some embodiments. The sandwich panel 300 comprises a first CLT layer 302, an interlayer 304, and a second CLT layer 306. The first and second CLT layers 302 and 306 provide the primary structural support, while the interlayer 304, disposed between the CLT layers, includes a viscoelastic material, such as bituthene, configured to provide energy dissipation through shear deformation under dynamic loading conditions. The interlayer 304 influences the damping characteristics of the panel assembly 300. Experimental investigations were conducted to examine the effect of varying the interlayer thickness on the damping ratio of the system. In these studies, the interlayer thickness was varied from approximately 1 mm to 10 mm.

The results demonstrated that increasing the thickness of the interlayer 304 leads to an increase in the damping ratio of the panel assembly 300. However, it was observed that the rate of increase in damping diminishes as the interlayer thickness becomes larger. Specifically, the damping ratio approaches an asymptotic limit of approximately 12%, beyond which further increases in interlayer thickness produce negligible improvements in damping performance. This asymptotic behavior is believed to depend on various parameters of the sandwich assembly, including the mechanical properties of the CLT layers 302 and 306, the viscoelastic properties of the interlayer 304, and the geometric configuration of the panel. Accordingly, selection of the interlayer thickness may be optimized based on desired damping performance and structural requirements without unnecessarily increasing material usage.

FIG. 3B illustrates a graphical representation 310 of Bituthene® thickness versus damping ratio 312, showing the relationship between a viscoelastic interlayer thickness 316 and the resulting damping ratio 314 in a composite structural system, according to some embodiments. The graph 310 depicts the results of an experimental and analytical study involving a CLT/Bituthene®/CLT sandwich panel configuration, wherein the thickness of the viscoelastic interlayer was varied between 1 mm and 10 mm to assess its effect on system damping. The curve 318 represents the damping ratio observed at each corresponding interlayer thickness. The vertical axis 314 plots the damping ratio, a dimensionless measure of energy dissipation capability, while the horizontal axis 316 indicates the thickness of the viscoelastic interlayer in millimeters (mm). As shown, the damping ratio increases progressively with increased interlayer thickness, indicating that a thicker viscoelastic layer enhances the energy dissipation capacity of the structural assembly.

However, the rate of increase in the damping ratio begins to diminish at higher thicknesses, approaching an asymptotic limit near a damping ratio of approximately 12%. This suggests that beyond a certain interlayer thickness, additional material yields diminishing returns in vibration control performance. The observed damping ceiling is believed to be dependent on multiple factors, including the mechanical properties of the CLT layers, the shear modulus and damping characteristics of the Bituthene® material, the adhesive bond strength, and the boundary conditions of the composite panel. Further investigation into these influencing parameters may allow for optimized interlayer thickness selection based on specific design requirements and performance objectives. The findings illustrated in FIG. 3B provide valuable guidance for structural designers seeking to balance material efficiency with vibration control performance in composite floor and wall systems incorporating viscoelastic damping layers. In some embodiments, the rate of increase in damping gradually decreases and approaches an asymptotic limit near 12%. This damping limit is currently believed to be influenced by the specific parameters of the sandwich structure.

### Example: 8×8 Grid

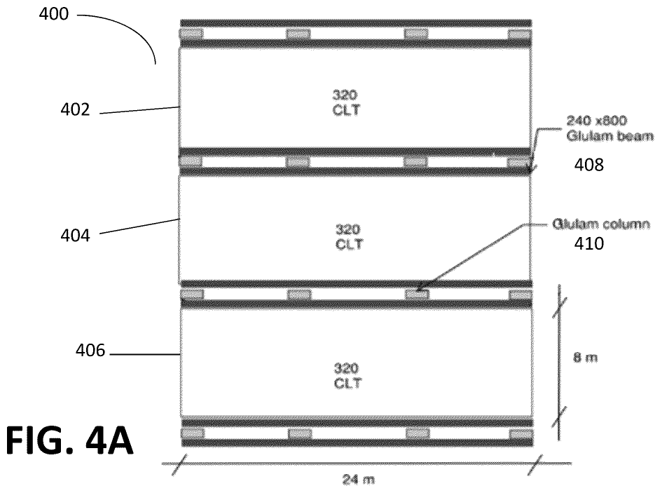

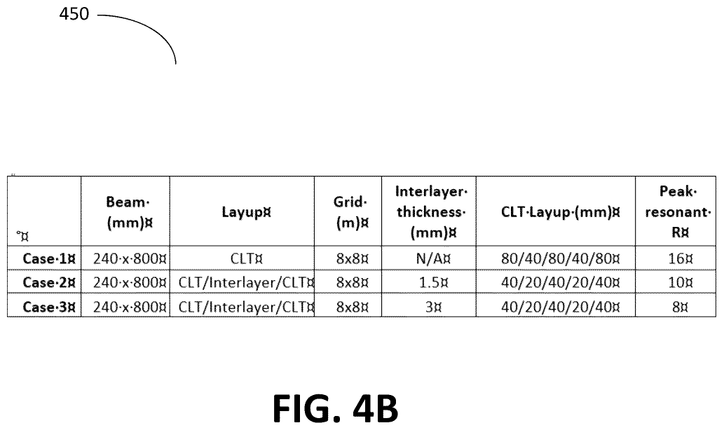

FIG. 4A illustrates a schematic elevation view of a multi-story structural system 400 configured with cross-laminated timber (CLT) floor assemblies and glulam support members, according to some embodiments. The structural system 400 includes multiple floor levels, with each floor assembly comprising a CLT slab. The first floor assembly 402, second floor assembly 404, and third floor assembly 406 are each constructed using 320 mm thick CLT panels. In some embodiments, the CLT panels may alternatively be configured as a sandwich assembly comprising two 160 mm CLT layers separated by an interlayer, such as a viscoelastic damping material, to improve vibration control and damping performance. The floor assemblies are supported by glulam beams 408 having cross-sectional dimensions of 240 mm by 800 mm. Vertical support is provided by glulam columns 410, which extend continuously through the structure. The structural grid layout is defined by spans of 9 meters by 8 meters, providing an open and efficient floor plan suitable for commercial or institutional buildings.

Whilst there is continuity across bays in the horizontal direction, there is unlikely to be continuity in the vertical direction due to the nature of the CLT-to-CLT joints and the presence of double beams, which effectively interrupt or “break” the continuity of vibrational modes between levels. Hence, the section of the floor at 404 can be modeled in isolation for purposes of vibration analysis and performance assessment. The performance of the isolated floor section was evaluated under dynamic loading conditions, including walking frequencies up to 2.5 Hz. The floor was analyzed under three configurations: (1) baseline without an interlayer, (2) with a 1.5 mm viscoelastic interlayer, and (3) with a 3 mm viscoelastic interlayer. It was found that adding a 3 mm interlayer reduced the resonant response factor (R value) from an unacceptable level of 16 down to a value of 8, which meets the standard vibration performance criteria for typical office floors. The system supports the use of interlayer damping systems to improve occupant comfort and structural performance in multi-story timber buildings, particularly where lightweight floor systems are susceptible to low-frequency resonant excitation.

FIG. 4B illustrates a table 450 that presents a comparative analysis of three structural configurations designed to assess the effect of incorporating a viscoelastic interlayer within a cross-laminated timber (CLT) floor system on its vibration performance. Each case evaluates the impact of interlayer thickness on the peak resonant response factor (R value), a critical indicator of floor vibration levels affecting occupant comfort. In all three cases, the floor system utilizes glulam beams measuring 240 mm by 800 mm, arranged on a structural grid with spans of 8 meters by 8 meters. Case 1 represents the baseline configuration, which employs a conventional solid CLT panel without any interlayer. The CLT layup in this case follows a sequence of 80 mm, 40 mm, 80 mm, 40 mm, and 80 mm thick layers, resulting in a relatively stiff but low-damping system. Under dynamic loading, such as walking excitation, this configuration exhibits a high peak resonant R value of 16, indicating unacceptable vibration performance for office environments.

In Case 2, the floor system is modified to include a 1.5 mm thick viscoelastic interlayer positioned between two CLT panels, forming a composite sandwich structure. Each CLT panel in this configuration is composed of thinner layers arranged in a 40 mm, 20 mm, 40 mm, 20 mm, and 40 mm sequence. This modified layup allows for increased relative movement between the layers and better energy dissipation through shear deformation of the interlayer. As a result, the peak resonant R value is significantly reduced to 10, demonstrating improved vibration performance compared to Case 1.

Case 3 further increases the interlayer thickness to 3 mm while maintaining the same CLT layup as in Case 2. This additional thickness enhances the damping capacity of the interlayer, allowing greater energy dissipation under vibrational excitation. Consequently, the peak resonant R value is further reduced to 8, meeting the standard vibration performance criteria typically required for office floors. Overall, the results clearly demonstrate that incorporating a viscoelastic interlayer within the floor system effectively reduces the peak resonant response. Increasing the thickness of the interlayer improves damping performance, thereby reducing perceptible vibrations and enhancing occupant comfort in the built environment. This system supports the strategic use of interlayer materials in modern timber floor construction to meet increasingly stringent vibration serviceability requirements.

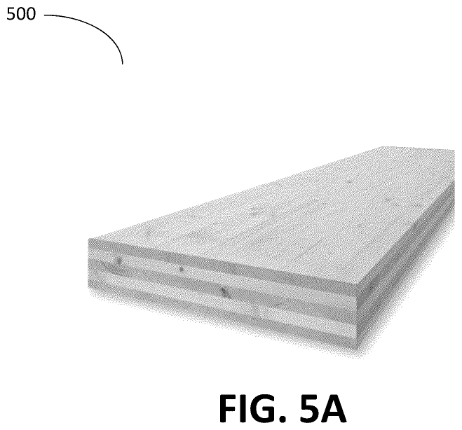

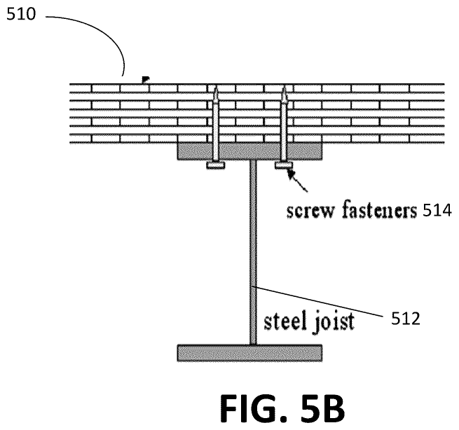

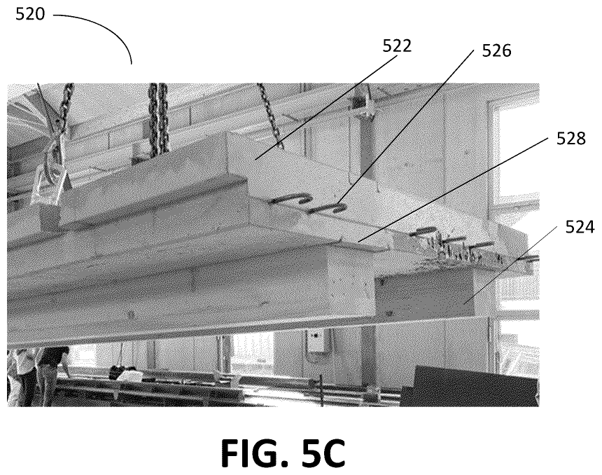

FIGS. 5A, 5B, and 5C illustrate three structural elements that may be used in supported floor systems where one or more viscoelastic layers can be introduced to increase damping. FIG. 5A specifically shows a five-layer cross-laminated timber (CLT) plank 500, which is commonly employed in mass timber construction for supported floors.

As shown in FIG. 5A, the CLT plank 500 is composed of five distinct timber layers arranged in a cross-laminated configuration. Each adjacent layer is oriented with its grain direction perpendicular to the preceding layer, enhancing the panel's structural rigidity and dimensional stability. This alternating grain orientation allows the CLT panel to resist bending and shear forces effectively, making it ideal for use as a primary load-bearing component in floor assemblies. The five-layer configuration provides increased stiffness and load-carrying capacity compared to thinner, three-layer alternatives, making it particularly suitable for longer floor spans or areas subject to higher dynamic loads. While the panel inherently provides some level of damping due to its mass and stiffness, it lacks significant inherent damping properties needed to reduce vibrational responses caused by walking or other dynamic excitations. To address this limitation, a viscoelastic interlayer can be introduced in combination with CLT elements like the plank shown in FIG. 5A. For example, rather than using a single thick CLT panel, the floor system may utilize two thinner CLT panels (e.g., 160 mm each) separated by a viscoelastic layer to form a composite assembly. This approach allows energy dissipation through shear deformation of the interlayer, significantly improving the damping ratio and reducing the resonant response of the floor system. Accordingly, the CLT plank 500 shown in FIG. 5A represents a foundational element for both traditional and advanced composite floor systems designed to meet modern vibration performance requirements in office, residential, and institutional buildings.

FIG. 5B illustrates a schematic cross-sectional view of a composite floor system 510 supported by a steel joist, according to some embodiments. The floor system 510 comprises a multi-layer cross-laminated timber (CLT) panel assembly positioned above a steel joist 512, which serves as a primary structural support. The CLT panel assembly includes several timber layers arranged to provide structural rigidity and distribute applied loads efficiently across the span of the floor. The CLT panels are mechanically connected to the steel joist 512 using screw fasteners 514, which extend through the panel layers and secure them to a horizontal steel plate atop the joist. These mechanical fasteners provide shear transfer between the CLT panels and the steel support system, ensuring composite action and load sharing between the materials.

In some embodiments, the screw fasteners 514 may be arranged in specific patterns to optimize structural performance and minimize the effects of differential movement between the timber and steel components. While the mechanical connection enhances structural integrity, it may also influence the dynamic behavior of the floor system by partially restraining slip at the interface, which could affect damping characteristics. The configuration shown in FIG. 5B is representative of hybrid timber-steel construction systems often used in commercial buildings to achieve long-span floor systems with efficient material utilization and improved vibration performance.

FIG. 5C illustrates a composite floor element 520 configured for integration into a structural floor system, according to some embodiments. The composite floor element 520 includes a cement surface portion 522 that forms a durable and wear-resistant upper surface suitable for direct use as a walking surface or as a base for additional floor finishes. Beneath the cement surface portion 522, one or more cross-laminated timber (CLT) supports 524 are provided to deliver structural strength and load-bearing capacity to the floor element. Embedded within the composite floor element 520 are one or more metal hooks 526. These metal hooks 526 are strategically positioned to provide secure anchoring points during installation and to facilitate mechanical interconnection with adjacent structural components or supporting frames. The metal hooks may also contribute to resisting uplift forces and maintaining positional stability of the floor element under dynamic loads.

The composite floor element 520 further includes overhanging edges 528 designed to engage with adjacent structural walls or framing members. These overhanging edges enable precise alignment and secure placement of the floor element within a building structure, reducing installation time and ensuring consistent load transfer between elements. This composite design combines the aesthetic and structural benefits of CLT with the durability and compressive strength of a cementitious surface, making the floor element well-suited for use in modular construction systems, commercial buildings, and residential applications requiring robust, prefabricated flooring solutions.

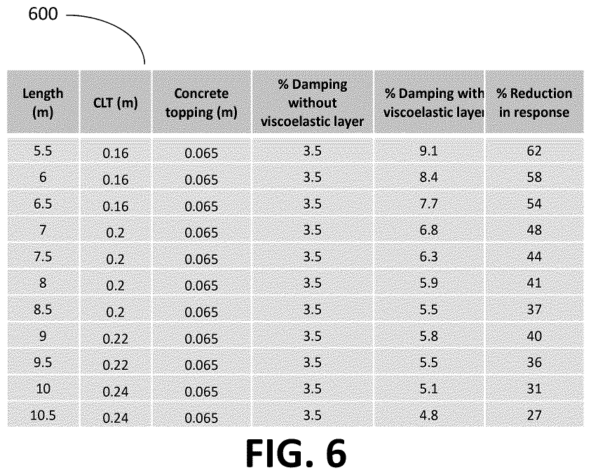

FIG. 6 shows damping information for a composite floor comprising CLE with a concrete topping. The data table 600 presents a comparative analysis evaluating the effect of incorporating a viscoelastic layer on the damping performance and vibration response reduction of such composite floor systems, according to some embodiments.

The table details results for various floor spans ranging from 5.5 meters to 10.5 meters. For each span length, the corresponding CLT panel thickness and concrete topping thickness are specified. The CLT thickness increases progressively from 0.16 meters for shorter spans to 0.24 meters for the longest spans, while the concrete topping remains constant at 0.065 meters across all cases to simulate consistent surface load conditions. The table further compares the percentage of damping without a viscoelastic layer, held constant at 3.5% for all configurations, against the improved damping values achieved by introducing a viscoelastic layer. The addition of the viscoelastic layer results in significantly higher damping percentages, starting at 9.1% for a 5.5-meter span and gradually decreasing to 4.8% for a 10.5-meter span, reflecting the diminishing relative effectiveness of the viscoelastic layer with increasing span length.

The final column quantifies the percentage reduction in vibration response due to the viscoelastic layer. The data shows that shorter spans benefit the most from the damping enhancement, with a response reduction of 62% at 5.5 meters. This reduction decreases progressively with increasing span lengths, reaching 27% at a span of 10.5 meters. This data demonstrates that the inclusion of a viscoelastic layer in a composite CLT-concrete floor system significantly improves damping characteristics and reduces resonant vibration responses, particularly in shorter spans. These improvements are critical for enhancing occupant comfort and meeting vibration performance criteria in office and commercial buildings.

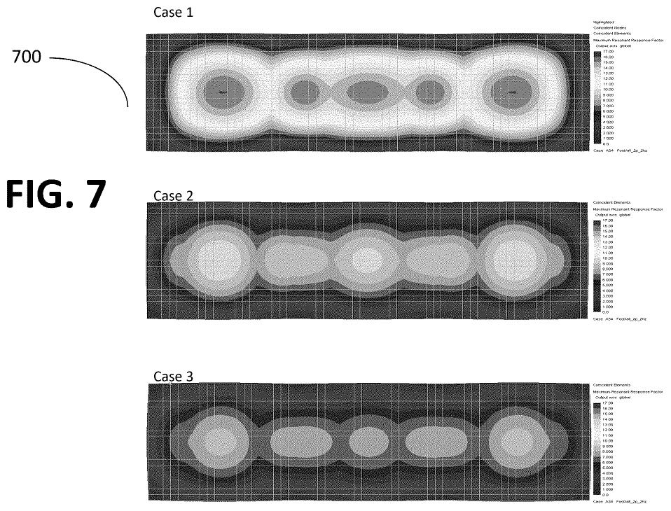

FIG. 7 illustrates a series of contour plots 700 representing the simulated resonant response of a floor system to dynamic excitation from foot traffic, according to some embodiments. The figure compares three cases with progressively increasing levels of damping, illustrating the corresponding reductions in vibrational response across the floor surface. In Case 1, the baseline configuration is shown, corresponding to a floor system without a viscoelastic interlayer. The contour plot reveals large high-response zones concentrated along the primary walking paths, with maximum resonant response factors exceeding acceptable thresholds. This configuration results in significant vibration levels, leading to potential occupant discomfort in building environments such as office spaces. Case 2 introduces a moderate level of damping, which may be achieved by incorporating a viscoelastic interlayer of approximately 1.5 mm thickness within the composite floor assembly. As illustrated, the high-response zones are noticeably reduced in both size and intensity compared to Case 1, indicating improved vibration performance. Case 3 demonstrates the highest damping level, achieved by further increasing the thickness of the viscoelastic interlayer to approximately 3 mm. The contour plot for Case 3 shows the most significant reduction in resonant response, with the high-response areas further minimized, resulting in a more uniform and acceptable vibration profile across the floor system. These results demonstrate that increasing the damping in a multilayer composite floor system, for example by increasing the thickness of a viscoelastic layer in a configuration having at least one CLT layer, effectively reduces the resonant response to foot traffic. This improvement enhances occupant comfort and ensures compliance with vibration performance standards typically required for office and commercial building environments.

Parameter study of damping achieved from CLT/Visco elastic layer/Timber topping composite sandwich.

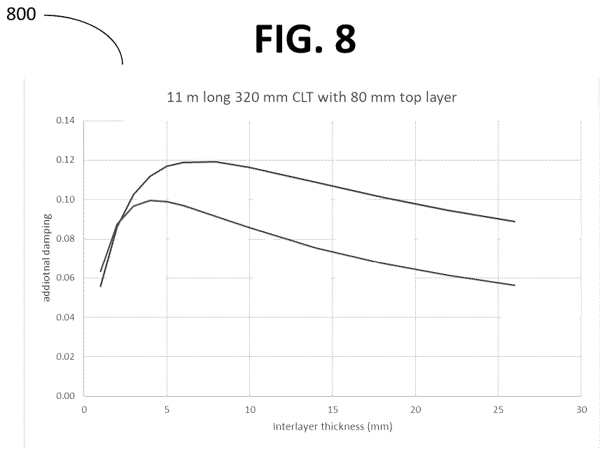

FIG. 8 illustrates a graph 800 showing an example of additional damping achieved in an 11-meter-spanning floor system comprising a 320 mm thick cross-laminated timber (CLT) panel with an 80 mm timber topping, evaluated across a range of temperatures and excitation frequencies. The horizontal axis of the graph represents the thickness of the viscoelastic interlayer in millimeters, while the vertical axis indicates the corresponding additional damping achieved. The plotted curves demonstrate how the damping performance varies with different interlayer thicknesses under varying temperature and frequency conditions.

The graph shows that as the interlayer thickness increases from 0 mm, the additional damping rises sharply, reaching a maximum value at approximately 5 mm thickness. Beyond this point, the damping effect plateaus and then gradually decreases with further increases in interlayer thickness. This behavior indicates that there is an optimal interlayer thickness for maximizing damping performance, beyond which the benefits diminish due to the reduced stiffness and effectiveness of the shear interface. This system highlights the importance of selecting an appropriate interlayer thickness to achieve optimal vibration control in long-span timber floor systems, considering the effects of both environmental conditions and dynamic loading frequencies.

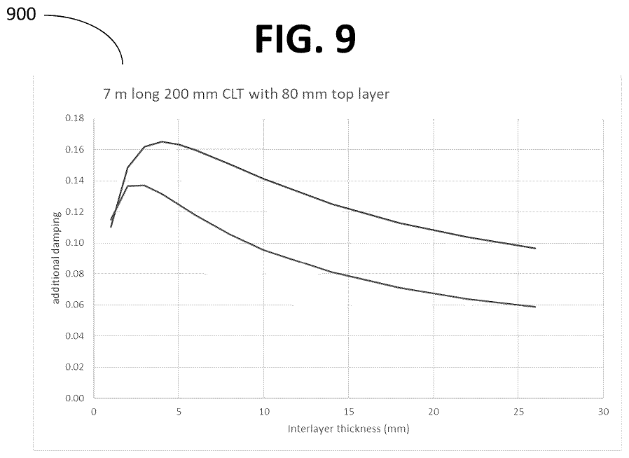

FIG. 9 illustrates a graph 900 representing the relationship between interlayer thickness and additional damping for a structural floor system configured with a 7-meter span, 200 mm thick cross-laminated timber (CLT) panel, and an 80 mm timber topping, according to some embodiments. The graph presents simulation results across a range of temperatures and excitation frequencies. The horizontal axis shows the interlayer thickness in millimeters, ranging from 0 mm to 25 mm, while the vertical axis indicates the corresponding additional damping achieved by introducing a viscoelastic interlayer. As shown, the additional damping increases rapidly with small increases in interlayer thickness, peaking at approximately 4 mm thickness. The maximum damping achieved reaches values between 0.14 and 0.16, depending on specific temperature and frequency conditions. Beyond this optimal thickness, additional damping gradually decreases, indicating diminishing effectiveness of thicker interlayers.

The curves demonstrate that thinner viscoelastic interlayers are more effective at enhancing damping performance in this specific configuration. Increasing the interlayer thickness beyond the optimal value does not yield significant gains and may instead reduce structural stiffness, impacting overall performance. This system highlights the importance of carefully selecting interlayer thickness based on span length, panel thickness, and service conditions to optimize vibration control and occupant comfort. The results confirm that for a 7-meter span with a 200 mm CLT panel and 80 mm timber topping, an interlayer thickness of approximately 4 mm offers the most effective damping enhancement.

### EXAMPLES

Clause 1. A method to increase damping to reduce structural vibration in a composite building material (composite) containing two structural layers sandwiching a viscoelastic interlayer, at least one of the structural layers comprising cross-laminated timber (CLT), CLT and concrete, glue laminated timber (glulam), or glulam and concrete, the method comprising: measuring a length and width of a support-free portion of the composite; assuming one or more mode shapes of free vibration of the composite portion are approximated by one or more sine waves, and a shear deflection of the layers is negligible; and calculating manually a damping of the composite portion within 6% of the damping for a composite portion calculated by a finite element analysis (FEA) program.

Clause 2. The method of clause 1, wherein the FEA program solves an equation: where:—is an effective damping of the composite portion for a given mode m—Transpose of mode shape vector for mode m—Stiffness matrix of element e alone expanded into a global stiffness matrix space—Mode shape vector for mode m—Global stiffness matrix

Clause 3. The method of clause 1, further comprising, a strain profile due to bending for each structural layer of the composite is: and: with maximum curvature and axial force in the structural layers given by: with: where:—Peak distributed inertial load—Effective flexural stiffness of structural layer 1—Effective flexural stiffness of structural layer 2—Effective axial stiffness of structural layer 1—Effective axial stiffness of structural layer 2—distance between centroids of the 2 structural layers—is a smeared shear stiffness of the viscoelastic interlayer (can have units of N/m per m run) and compressive strain is taken as positive.

Clause 4. The method of clause 3, further comprising a total strain energy in the composite is given by: where: and:

Clause 5. The method of clause 4, further comprising a shear strain energy due to shearing of the viscoelastic layer is given by:

Clause 6. The method of clause 5, further comprising a shear flow along the composite is given by:

Clause 7. The method of clause 6, wherein the shear strain energy at the interlayer is given by: where:

Clause 8. The method of clause 7, further comprising an equivalent damping of the composite is: where: with: where: is an effective flexural stiffness of a structural layer 1 is an effective flexural stiffness of a structural layer 2—is an effective axial stiffness of the structural layer 1—is an effective axial stiffness of the structural layer 2

Clause 9. The method of clause 8, wherein mode shapes are all assumed to be sine waves, and the damping of any mode n with n half sine waves is calculated by setting:

Clause 10. The method of clause 1, wherein the composite includes at least one additional structural layer, the method further comprising: modifying the calculation to include one or more terms pertaining to each respective additional structural layer in the composite.

Clause 11. A composite building material (composite) that damps structural vibrations, comprising: two structural layers sandwiching a viscoelastic interlayer, at least one of the structural layers comprising cross-laminated timber (CLT), CLT and concrete, glue laminated timber (glulam), or glulam and concrete.

Clause 12. The composite of clause 11, wherein an estimate of composite damping is calculated assuming one or more mode shapes of free vibration of a support-free portion of the composite is approximated by one or more sine waves, and a shear deflection of the layers is negligible; and the estimate is within 6% of the damping for a same composite portion calculated by a finite element analysis (FEA) program.

Clause 13. The composite of clause 12, wherein the calculating accounts for a strain profile due to bending for each structural layer of the composite as: and: with maximum curvature and axial force in the structural layers given by: with: where:—Peak distributed inertial load—Effective flexural stiffness of structural layer 1—Effective flexural stiffness of structural layer 2—Effective axial stiffness of structural layer 1—Effective axial stiffness of structural layer 2—distance between centroids of the 2 structural layers—is a smeared shear stiffness of the viscoelastic interlayer (can have units of N/m per m run) and compressive strain is taken as positive.

Clause 14. The composite of clause 13, wherein the calculating accounts for a total strain energy in the composite by evaluating: where: and:

Clause 15. The composite of clause 14, wherein the calculating accounts for a shear strain energy due to shearing of the viscoelastic layer by evaluating:

Clause 16. The composite of clause 15, wherein the calculating accounts for a shear flow along the composite by evaluating:

Clause 17. The composite of clause 16, wherein the calculating accounts for a shear strain energy at the interlayer by evaluating: where:

Clause 18. The composite of clause 17, wherein the calculating accounts for an equivalent damping of the composite by evaluating: where: with: where:—Effective flexural stiffness of structural layer 1—Effective flexural stiffness of structural layer 2—Effective axial stiffness of structural layer 1—Effective axial stiffness of structural layer 2

Clause 19. The composite of clause 18, wherein the calculating assumes all mode shapes are sine waves, and the damping of any mode n with n half sine waves is evaluated by setting:

Clause 20. The composite of clause 13, further comprising at least one additional structural layer: further comprising calculating is modified to include one or more terms pertaining to each respective additional structural layer in the composite.

Clause 21. A composite building material (composite) that damps structural vibration, comprising two structural layers sandwiching a viscoelastic interlayer, at least one of the structural layers comprising cross-laminated timber (CLT), CLT and concrete, glue laminated timber (glulam), or glulam and concrete.

Clause 22. A composite as in clause 21, included in a system with a supported floor comprising the composite, the system further comprising: at least one structural beam supporting the floor; and a second viscoelastic layer disposed between and in contact with the structural beam and the floor it supports.

Clause 23. A composite as in clause 22, wherein the system further includes at least one of a composite floor slab, a composite support beam, a composite T beam, and an entire composite slab on composite beam floor system.

Although the invention has been described and illustrated in exemplary forms with a certain degree of particularity, it is noted that the description and illustrations have been made by way of example only. Numerous changes in the details of construction, combination, and arrangement of parts and steps may be made without deviating from the scope of the invention. Accordingly, such changes are understood to be inherent in the disclosure. The invention is not limited except by the appended claims and the elements explicitly recited therein. The scope of the claims should be construed as broadly as the prior art will permit. It should also be noted that all elements of all of the claims may be combined with each other in any possible combination, even if the combinations have not been expressly claimed.

What is claimed is:

1. A method to increase damping to reduce structural vibration in a composite building material (composite) containing two structural layers sandwiching a viscoelastic interlayer, at least one of the structural layers comprising cross-laminated timber (CLT), CLT and concrete, glue laminated timber (glulam), or glulam and concrete, the method comprising:
measuring a length and width of a support-free portion of the composite;
assuming one or more mode shapes of free vibration of the composite portion are approximated by one or more sine waves, and a shear deflection of the layers is negligible; and
calculating manually a damping of the composite portion within 6% of the damping for a composite portion calculated by a finite element analysis (FEA) program.

2. The method of claim 1, wherein the FEA program solves an equation:
$${ξ}_{eff , n} = \frac{{\sum }_{e = 1}^{N} \frac{1}{2} {ξ}_{e} {φ}_{n}^{T} {K}_{e}^{G l} {φ}_{n}}{\frac{1}{2} {φ}_{n}^{T} K {φ}_{n}} = \frac{{\sum }_{e = 1}^{N} {ξ}_{e} {φ}_{n}^{T} {K}_{e}^{G l} {φ}_{n}}{{φ}_{n}^{T} K {φ}_{n}}$$
where:
ξₑ—is an effective damping of the composite portion for a given mode m
$${φ}_{n}^{T}$$
—Transpose of mode shape vector for mode m
$${K}_{e}^{G l}$$
—Stiffness matrix of element e alone expanded into a global stiffness matrix space
φₙ—Mode shape vector for mode m
K—Global stiffness matrix

3. The method of claim 1, further comprising, a strain profile due to bending for each structural layer of the composite is:
$${ε}_{1} ( x , {y}_{1} ) = [ {w}_{max}^{″} ( \frac{{h}_{1}}{2} - {y}_{1} ) + \frac{{N}_{max}}{{( E A )}_{1}} ] sin ( \frac{π x}{l} )$$
and:
$${ε}_{2} ( x , {y}_{2} ) = [ {w}_{max}^{″} ( \frac{{h}_{2}}{2} - {y}_{2} ) + \frac{{N}_{max}}{{( E A )}_{2}} ] sin ( \frac{π x}{l} )$$
with maximum curvature and axial force in the structural layers given by:
$${w}_{max}^{″} = \frac{{p}_{0} {( \frac{π}{l} )}^{2} ( \frac{μ}{{π}^{2} + {α}^{2}} - 1 )}{{( E I )}_{1} + {( E I )}_{2}}$$
$${N}_{max} = {p}_{0} {( \frac{π}{l} )}^{2} ( \frac{μ}{e {α}^{2}} ) ( 1 - \frac{{π}^{2}}{{π}^{2} + {α}^{2}} )$$
with:
$${α}^{2} = ( \frac{1}{{( E A )}_{1}} + \frac{1}{{( E A )}_{2}} + \frac{{e}^{2}}{{( E I )}_{1} + {( E I )}_{2}} ) {k}_{s} {l}^{2}$$
$$μ = ( \frac{{k}_{s} {l}^{2} {e}^{2}}{{( E I )}_{1} + {( E I )}_{2}} )$$
where:
p₀—Peak distributed inertial load
(EI)₁—Effective flexural stiffness of structural layer 1
(EI)₂—Effective flexural stiffness of structural layer 2
(EA)₁—Effective axial stiffness of structural layer 1
(EA)₂—Effective axial stiffness of structural layer 2
e—distance between centroids of the 2 structural layers
kₛ—is a smeared shear stiffness of the viscoelastic interlayer (can have units of N/m per m run)
and compressive strain is taken as positive.

4. The method of claim 3, further comprising a total strain energy in the composite is given by:
$${U}_{b} = {U}_{b 1} + {U}_{b 2}$$
where:
$${U}_{b} = \frac{{E}_{1} {b}_{1}}{2} {\int }_{0}^{l} {\int }_{0}^{{h}_{1}} {ε}_{1}^{2} {dy}_{1} {dx}_{1} + \frac{{E}_{2} {b}_{2}}{2} {\int }_{0}^{l} {\int }_{0}^{{h}_{2}} {ε}_{2}^{2} {dy}_{2} {dx}_{2}$$
and:
$${U}_{b} = \frac{{E}_{1} {b}_{1} l}{2} [ \frac{{( {w}_{max}^{″} )}^{2} {h}_{1}^{3}}{24} + \frac{{N}_{max}^{2} {h}_{1}}{2 {( E A )}_{1}^{2}} ] + \frac{{E}_{2} {b}_{2} l}{2} [ \frac{{( {w}_{max}^{″} )}^{2} {h}_{2}^{3}}{24} + \frac{{N}_{max}^{2} {h}_{2}}{2 {( E A )}_{2}^{2}} ]$$

5. The method of claim 4, further comprising a shear strain energy due to shearing of the viscoelastic layer is given by:
$${U}_{S} = \frac{1}{2} {\int }_{0}^{l} \frac{{[ v ( x ) ]}^{2}}{{k}_{s}} d x$$

6. The method of claim 5, further comprising a shear flow along the composite v(x) is given by:
$$v ( x ) = {v}_{max} cos ( \frac{π x}{l} )$$

7. The method of claim 6, wherein the shear strain energy at the interlayer is given by:
$${U}_{S} = \frac{{v}_{max}^{2} l}{4 {k}_{s}}$$
where:
$${v}_{max} = {p}_{max} \cdot \frac{l}{π} \cdot \frac{μ}{e {α}^{2}} \cdot ( 1 - \frac{{π}^{2}}{{π}^{2} + {α}^{2}} )$$

8. The method of claim 7, further comprising an equivalent damping of the composite is:
$${ξ}_{eff , n} = \frac{{U}_{S , n}}{{U}_{Tot , n}} = \frac{{ξ}_{1} {U}_{b 1} + {ξ}_{2} {U}_{b 2} + {ξ}_{s} {U}_{S}}{{U}_{b 1} + {U}_{b 2} + {U}_{S}}$$
where:
$${ξ}_{eff , n} = {ξ}_{eff , n , s} + {ξ}_{eff , n , 1} + {ξ}_{eff , n , 2}$$
with:
$${ξ}_{eff , n , s} = \frac{{ξ}_{s} {μ}^{2} {π}^{2} ( {D}_{1} + {D}_{2} )}{{l}^{2} {e}^{2} {k}_{s} ( {π}^{2} + {α}^{2} - μ ) ( {π}^{2} + {α}^{2} )}$$
$${ξ}_{eff , n , 1} = \frac{{ξ}_{1} [ {C}_{1}^{2} {e}^{2} {{h}_{1}^{2} ( {π}^{2} + {α}^{2} - μ )}^{2} + 12 {{μ}^{2} ( {D}_{1} + {D}_{2} )}^{2} ]}{12 {C}_{1} {e}^{2} ( {D}_{1} + {D}_{2} ) ( {π}^{2} + {α}^{2} - μ ) ( {π}^{2} + {α}^{2} )}$$
$${ξ}_{eff , n , 2} = \frac{{ξ}_{2} [ {C}_{2}^{2} {e}^{2} {{h}_{2}^{2} ( {π}^{2} + {α}^{2} - μ )}^{2} + 12 {{μ}^{2} ( {D}_{1} + {D}_{2} )}^{2} ]}{12 {C}_{2} {e}^{2} ( {D}_{1} + {D}_{2} ) ( {π}^{2} + {α}^{2} - μ ) ( {π}^{2} + {α}^{2} )}$$
where:
D₁ is an effective flexural stiffness of a structural layer 1
D₂ is an effective flexural stiffness of a structural layer 2
C₁—is an effective axial stiffness of the structural layer 1
C₂—is an effective axial stiffness of the structural layer 2

9. The method of claim 8, wherein mode shapes are all assumed to be sine waves, and the damping of any mode n with n half sine waves is calculated by setting:
$$l = \frac{span}{n}$$

10. The method of claim 1, wherein the composite includes at least one additional structural layer, the method further comprising:
modifying the calculation to include one or more terms pertaining to each respective additional structural layer in the composite.

11. A composite building material (composite) that damps structural vibrations, comprising:
two structural layers sandwiching a viscoelastic interlayer, at least one of the structural layers comprising cross-laminated timber (CLT), CLT and concrete, glue laminated timber (glulam), or glulam and concrete.

12. The composite of claim 11, wherein an estimate of composite damping is calculated assuming one or more mode shapes of free vibration of a support-free portion of the composite is approximated by one or more sine waves, and a shear deflection of the layers is negligible; and
the estimate is within 6% of the damping for a same composite portion calculated by a finite element analysis (FEA) program.

13. The composite of claim 12, wherein the calculating accounts for a strain profile due to bending for each structural layer of the composite as:
$${ε}_{1} ( x , {y}_{1} ) = [ {w}_{m ax}^{″} ( \frac{{h}_{1}}{2} - {y}_{1} ) + \frac{{N}_{m ax}}{{( EA )}_{1}} ] sin ( \frac{π x}{l} )$$
and:
$${ε}_{2} ( x , {y}_{2} ) = [ {w}_{m ax}^{″} ( \frac{{h}_{2}}{2} - {y}_{2} ) - \frac{{N}_{m ax}}{{( EA )}_{2}} ] sin ( \frac{π x}{l} )$$
with maximum curvature and axial force in the structural layers given by:
$${w}_{m ax}^{″} = \frac{{{p}_{0} ( \frac{π}{l} )}^{2} ( \frac{μ}{{π}^{2} + {α}^{2}} - 1 )}{{( EI )}_{1} + {( EI )}_{2}} \\ {N}_{m ax} = {{p}_{0} ( \frac{π}{l} )}^{2} ( \frac{μ}{e {α}^{2}} ) ( 1 - \frac{{π}^{2}}{{π}^{2} + {α}^{2}} )$$
with:
$${α}^{2} = ( \frac{1}{{( EA )}_{1}} + \frac{1}{{( EA )}_{2}} + \frac{{e}^{2}}{{( EI )}_{1} + {( EI )}_{2}} ) {k}_{s} {l}^{2} \\ μ = ( \frac{{k}_{s} {l}^{2} {e}^{2}}{{( EI )}_{1} + {( EI )}_{2}} )$$
where:
p₀—Peak distributed inertial load
(EI)₁—Effective flexural stiffness of structural layer 1
(EI)₂—Effective flexural stiffness of structural layer 2
(EA)₁—Effective axial stiffness of structural layer 1
(EA)₂—Effective axial stiffness of structural layer 2
e—distance between centroids of the 2 structural layers
kₛ—is a smeared shear stiffness of the viscoelastic interlayer (can have units of N/m per m run)
and compressive strain is taken as positive.

14. The composite of claim 13, wherein the calculating accounts for a total strain energy in the composite by evaluating:
$${U}_{b} = {U}_{b 1} + {U}_{b 2}$$
where:
$${U}_{b} = \frac{{E}_{1} {b}_{1}}{2} {\int }_{0}^{l} {\int }_{0}^{{h}_{1}} {ε}_{1}^{2} {dy}_{1} {dx}_{1} + \frac{{E}_{2} {b}_{2}}{2} {\int }_{0}^{l} {\int }_{0}^{{h}_{2}} {ε}_{2}^{2} {dy}_{2} {dx}_{2}$$
and:
$${U}_{b} = \frac{{E}_{1} {b}_{1} l}{2} [ \frac{{( {w}_{m ax}^{″} )}^{2} {h}_{1}^{3}}{24} + \frac{{N}_{ma x}^{2} {h}_{1}}{2 {( EA )}_{1}^{2}} ] + \frac{{E}_{2} {b}_{2} l}{2} [ \frac{{( {w}_{m ax}^{″} )}^{2} {h}_{2}^{3}}{24} + \frac{{N}_{ma x}^{2} {h}_{2}}{2 {( EA )}_{2}^{2}} ]$$

15. The composite of claim 14, wherein the calculating accounts for a shear strain energy due to shearing of the viscoelastic layer by evaluating:
$${U}_{S} = \frac{1}{2} {\int }_{0}^{l} \frac{{[ v ( x ) ]}^{2}}{{k}_{s}} dx$$

16. The composite of claim 15, wherein the calculating accounts for a shear flow along the composite v(x) by evaluating:
$$v ( x ) = {v}_{m ax} cos ( \frac{π x}{l} )$$

17. The composite of claim 16, wherein the calculating accounts for a shear strain energy at the interlayer by evaluating:
$${U}_{S} = \frac{{v}_{m ax}^{2} l}{4 {k}_{s}}$$
where:
$${v}_{m ax} = {p}_{m ax} \cdot \frac{l}{π} . \frac{μ}{e {α}^{2}} \cdot ( 1 - \frac{{π}^{2}}{{π}^{2} + {α}^{2}} )$$

18. The composite of claim 17, wherein the calculating accounts for an equivalent damping of the composite by evaluating:
$${ξ}_{eff , n} = \frac{{U}_{S , n}}{{U}_{Tot , n}} = \frac{{ξ}_{1} {U}_{b 1} + {ξ}_{2} {U}_{b 2} + {ξ}_{s} {U}_{S}}{{U}_{b 1} + {U}_{b 2} + {U}_{S}}$$
where:
$${ξ}_{eff , n} = {ξ}_{eff , n s} + {ξ}_{eff , n , 1} + {ξ}_{eff , n , 2}$$
with:
$${ξ}_{eff , n s} = \frac{{ξ}_{s} {μ}^{2} {π}^{2} ( {D}_{1} + {D}_{2} )}{{l}^{2} {e}^{2} {k}_{s} ( {π}^{2} + {α}^{2} - μ ) ( {π}^{2} + {α}^{2} )}$$
$${ξ}_{eff , n , 1} = \frac{{ξ}_{1} [ {C}_{1}^{2} {e}^{2} {{h}_{1}^{2} ( {π}^{2} + {α}^{2} - μ )}^{2} + 12 {{μ}^{2} ( {D}_{1} + {D}_{2} )}^{2} ]}{12 {C}_{1} {e}^{2} ( {D}_{1} + {D}_{2} ) ( {π}^{2} + {α}^{2} - μ ) ( {π}^{2} + {α}^{2} )}$$
$${ξ}_{eff , n , 2} = \frac{{ξ}_{2} [ {C}_{2}^{2} {e}^{2} {{h}_{2}^{2} ( {π}^{2} + {α}^{2} - μ )}^{2} + 12 {{μ}^{2} ( {D}_{1} + {D}_{2} )}^{2} ]}{12 {C}_{2} {e}^{2} ( {D}_{1} + {D}_{2} ) ( {π}^{2} + {α}^{2} - μ ) ( {π}^{2} + {α}^{2} )}$$
where:
D₁—Effective flexural stiffness of structural layer 1
D₂—Effective flexural stiffness of structural layer 2
C₁—Effective axial stiffness of structural layer 1
C₂—Effective axial stiffness of structural layer 2

19. The composite of claim 18, wherein the calculating assumes all mode shapes are sine waves, and the damping of any mode n with n half sine waves is evaluated by setting:
$$l = \frac{span}{n}$$

20. The composite of claim 13, further comprising at least one additional structural layer:
further comprising calculating is modified to include one or more terms pertaining to each respective additional structural layer in the composite.

21. A composite building material (composite) that damps structural vibration, comprising two structural layers sandwiching a viscoelastic interlayer, at least one of the structural layers comprising cross-laminated timber (CLT), CLT and concrete, glue laminated timber (glulam), or glulam and concrete.

22. A composite as in claim 21, included in a system with a supported floor comprising the composite, the system further comprising:
at least one structural beam supporting the floor; and
a second viscoelastic layer disposed between and in contact with the structural beam and the floor it supports.

23. A composite as in claim 22, wherein the system further includes at least one of a composite floor slab, a composite support beam, a composite T beam, and an entire composite slab on composite beam floor system.
